(19) United States
(12) Patent Application Publication
(10) Pub. No.: US 2024/0103792 A1
(43) Pub. Date: Mar. 28, 2024

(54) DYNAMIC CUSTOMIZATION OF MEETING EXPERIENCES

(71) Applicant: INTERNATIONAL BUSINESS MACHINES CORPORATION, ARMONK, NY (US)

(72) Inventors: Dana L. Price, Surf City, NC (US); Diane Chalmers, Rochester, MN (US); Nicholas Tsang, Saratoga, CA (US)

(21) Appl. No.: 17/934,582

(22) Filed: Sep. 23, 2022

(51) Int. Cl. G06F 3/14; G06T 3/40; G06T 11/00; H04N 5/262

(52) U.S. Cl. CPC G06F 3/1454; G06T 3/40; G06T 11/001; H04N 5/2628; G06V 30/10

(57) ABSTRACT

According to one embodiment, a method, computer system, and computer program product for dynamically customizing meeting experiences is provided. The embodiment may include initiating a video call. The embodiment may also include determining one or more sets of user preferences for one or more users. The embodiment may further include identifying visual characteristics of a main video stream on the video call. The embodiment may also include adjusting one or more visual characteristics of the main video stream according to the one or more sets of user preferences to create one or more custom video streams for the one or more users.

### BACKGROUND

The present invention relates generally to the field of computing, and more particularly to web conferencing.

Web conferencing is a field of telecommunications that facilitates video, audio, and text-based meetings and discussions over telecommunications networks. Video might include recorded video of a user or a video stream of a user's screen. Screen sharing can be important for presentations, negotiations, UI design, or other important purposes, by enabling users to share text, photos, and other media types shared on the presenter's screen. Video conferencing solutions often also involve audio and text chat, as well as features such as call recording, transactions, zooming controls, and filters.

### SUMMARY

According to one embodiment, a method, computer system, and computer program product for dynamically customizing meeting experiences is provided. The embodiment may include initiating a video call. The embodiment may also include determining one or more sets of user preferences for one or more users. The embodiment may further include identifying visual characteristics of a main video stream on the video call. The embodiment may also include adjusting one or more visual characteristics of the main video stream according to the one or more sets of user preferences to create one or more custom video streams for the one or more users.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computing environment according to at least one embodiment.

FIG. 2 illustrates an operational flowchart for a process for dynamically customizing meeting experiences for users according to at least one embodiment.

FIG. 3 depicts a block diagram of a screen sharing session according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to web conferencing. The following described exemplary embodiments provide a system, method, and program product to, among other things, dynamically customize meeting experiences for users. Therefore, the present embodiment has the capacity to improve the technical field of web conferencing by providing a process to provide users with customized streams of a video stream according to various preferences.

As previously described, web conferencing is a field of telecommunications that facilitates video, audio, and text-based meetings and discussions over telecommunications networks. Video might include recorded video of a user or a video stream of a user's screen. Screen sharing can be important for presentations, negotiations, UI design, or other important purposes, by enabling users to share text, photos, and whatever else might appear on the presenter's screen. Video chatting solutions often also involve audio and text chat, as well as features like call recording, transactions, zooming controls, and filters.

Due to various connection settings, configuration options, and user attributes, participants on a web conference call may have different preferences or needs. For example, some participants may be colorblind and require specific color schemes to view content effectively. Some users may prefer or need lower contrast, larger font sizes, larger photos or other elements, or increased brightness. As such, it may be advantageous to customize each user's viewing experience of a shared video stream dynamically.

According to at least one embodiment, at the initiation of a web conference, video chat, or similar digital meeting, a program may determine user preferences or needs. The program may then identify stream characteristics that conflict with user preferences, possibly giving special attention to areas on which users are focused, and then customize streams to each user according to the preferences or needs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as meeting experience customization program 150. In addition to meeting experience customization program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and meeting experience customization program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

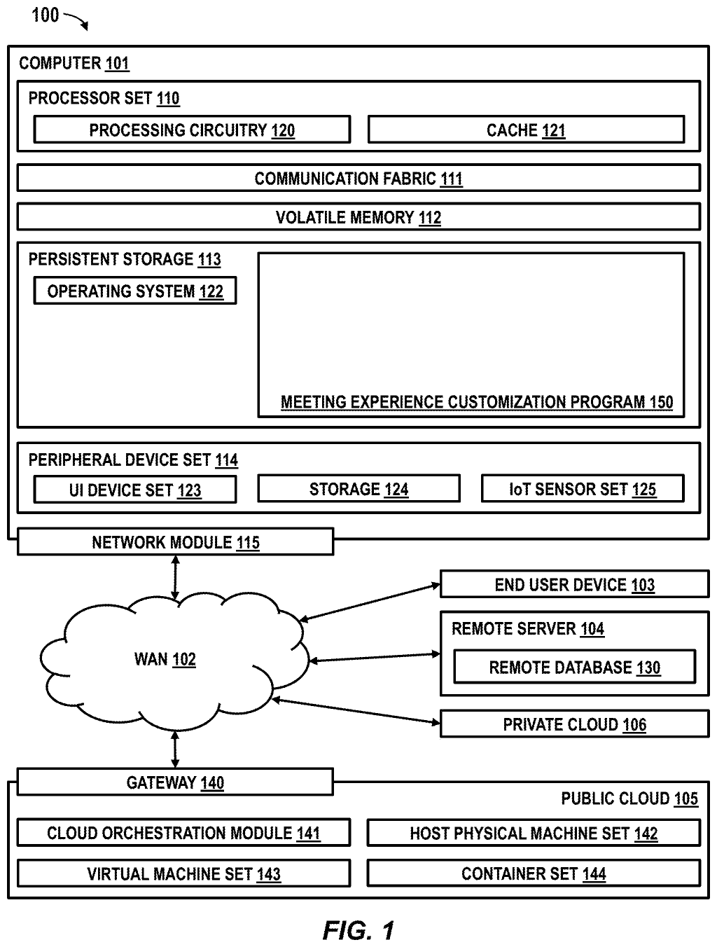

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in meeting experience customization program 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in meeting experience customization program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi® network. The WAN 102 and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

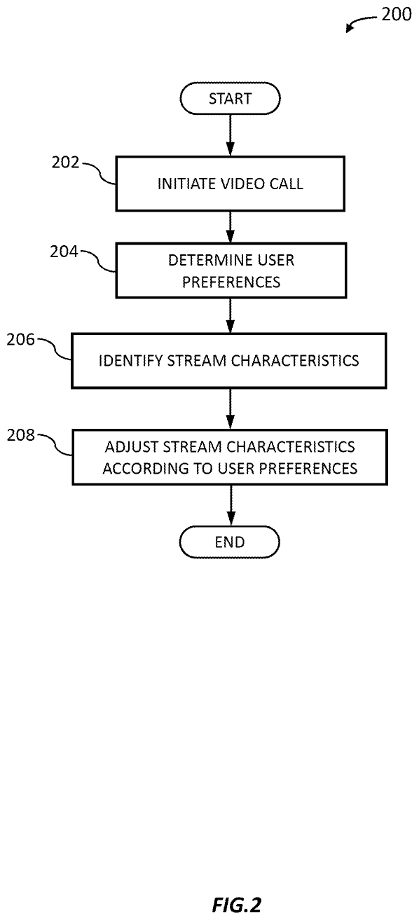

Meeting experience customization program 150 may be a set of computer instructions that carry out the inventive steps. The meeting experience customization program 150 may initiate a video call. The meeting experience customization program 150 may then determine user preferences and needs, and analyze the video stream for issues relating to those preferences and needs. For example, if users require a minimum text size for legibility, the meeting experience customization program 150 may analyze text sizes present in the video stream. The meeting experience customization program 150 may, accordingly, adjust stream characteristics to account for such conflicts, customizing streams for users as required. Notwithstanding depiction in computer 101, meeting experience customization program 150 may be stored in and/or executed by, individually or in any combination, end user device 103, remote server 104, public cloud 105, and private cloud 106. The method for dynamically customizing meeting experiences is explained in further detail below with respect to FIG. 2.

Referring now to FIG. 2, an operational flowchart illustrating a process for dynamically customizing meeting experiences for users 200 is depicted according to at least one embodiment. At 202, the meeting experience customization program 150 initiates a video call. A video call may include a digital meeting, call, conference, or stream, where users share at least one stream of video, including video of a user, video recorded by a user, and video of a user's screen.

In a preferred embodiment, a video call may include shared video of a user's screen through screen sharing. Screen sharing may include sharing all or part of a presenter's or other user's screen. Screen sharing may be used, for example, in the context of a presentation for a business meeting; in the context of a contract negotiation; in the context of a collaborative user interface design process; in the context of video game streaming on a popular streaming service; or in the context of a friendly watch party through a video streaming service. Alternatively, a video call may include video recorded of or by a user, or any other stream of video from any other source. For example, a video call may include a live recording of a presenter giving a presentation with text visible on a projector screen near the presenter. As yet another embodiment, a video call may further include other communication methods, including one or more audio streams, text-based chat, still images, emoticons, animations, reactions, backgrounds, and filters.

In at least one embodiment, initiating may include determining the time of the call, identifying an agenda, identifying one or more users including presenters and other participants, determining access levels, alerting a user about a meeting, or setting initial variables for the call. Initiating may be performed at any point before the call. Alternatively, initiating may be performed at or around the start of the call. For example, alerting a user about a meeting may include sending a meeting invite, sending a meeting reminder, ringing a ringtone on a user's device, or messaging an access link to a user.

In yet another embodiment, identifying users may include determining one or more of a meeting scheduler, host, leader, presenter, or administrator. Identifying users may also include other participants such as attendees, viewers, or people with access to view a recording of the call after it is performed. Identifying users may be used to determine user preferences at 204. One or more users may set no user preferences at all.

In at least one embodiment, setting initial meeting variables may include, for example, determining other data regarding participants; devices; company policies including security policies, data retention policies, or storage space policies; data about past meetings; network data; historical data regarding past meetings; and any other data that may be useful in machine learning and artificial intelligence.

Then, at 204, the meeting experience customization program 150 determines user preferences for one or more participants in the call. User preferences may include, for example, general aesthetic preferences, accessibility needs, technical preferences. User preferences may be identified by users, determined by an algorithmic process, determined by a process of artificial intelligence, or determined by a combination of these methods.

In an embodiment where user preferences are identified by users, users may input their preferences, accessibility needs, or similar settings in a graphical user interface. Preferences may include, for example, options to turn on a high-contrast text mode, reduce contrast in general, set a minimum text size, or increase brightness.

In an alternate embodiment, user preferences may be determined by an algorithmic process. For example, an algorithmic process may determine the minimum readable text size on each user's device based on a screen size and current window size. Alternatively, an algorithmic process may combine user-input preferences with analysis of data. For example, users may set desired text size on a non-numerical scale from “very small” to “very large,” and an algorithmic process may determine an appropriate text size based on this setting, a screen size, current window size, and other contextual data collected regarding the stream or the participant.

In another embodiment, an algorithmic process may include a process of artificial intelligence, which may utilize such techniques as deep learning or neural networks. A process of artificial intelligence may further include gathering information before, during, and after a call. For example, the meeting experience customization program 150 may ask a portion of users if they were able to read text comfortably after a call and correlate that information with data about the text during the call and data about the users for use in machine learning about setting the optimal text size.

In at least one embodiment, data associated with users may be collected according to an opt-in procedure. For example, a post-call questionnaire may ask users questions about their call experience and include a check box users can select asking if they would like to opt in to collection of responses to their questionnaires for machine learning purposes. As another example, users may agree to automatic data collection before a call.

In yet another embodiment, user settings may be set by default. For example, the meeting experience customization program 150 may determine that users by default need text to be at least a third of an inch tall on their target devices, at least as big as an eight point font on any target device, or at least 40 pixels tall to provide sufficient detail to be legible, or that text must meet more than one of these minimum requirements.

In a further embodiment, user preferences may include preferences based on a presenter. For example, if historical data from past meetings indicates that text in the presenter's past presentations is often too small to read, one or more user preferences may be set to prefer an increased text size.

Then, at 206, the meeting experience customization program 150 identifies stream characteristics that may be incongruous or discordant with the preferences of one and more users. Stream characteristics may include colors, typefaces, text sizes or font sizes, spacing, and scale of objects. Incongruities may include, for example, a text size being too small or too large, or contrast between two colors being too high or too low.

In at least one embodiment, elements may be identified by a process of image recognition. Image recognition may be used, for example, in the context of screen sharing, live video, or still photo messaging. Image recognition may be used to detect text within an image, determine text sizes or other text features, identify colors, identify visible objects, and gather data that may otherwise be useful for machine learning by an opt-in procedure.

In another embodiment, characteristics may be identified by other algorithmic processes. For example, the meeting experience customization program 150 may utilize operating system APIs or APIs for software being shared on the screen to directly identify text, exact font size, color, and other text characteristics. Operating system APIs may also be used to identify window sizes and positions, a current location of a mouse cursor or text caret, or information about a screen, such as screen color specifications.

In at least one embodiment, the meeting experience customization program 150 may determine a point of focus at which to identify stream characteristics. A point of focus may be a location of a mouse cursor or text caret, at a point corresponding to an agenda topic, or a point identified by audio recognition. For example, if a user mentions “the presentation,” or if a current topic corresponds to a presentation, the meeting experience customization program 150 may identify presentation software, or a presentation area within the presentation software, as a point of focus.

In a further embodiment, the meeting experience customization program 150 may identify more than one point of focus. For example, the meeting experience customization program 150 may identify a point of focus for each set of user settings. The meeting experience customization program 150 may prioritize image recognition or other resource-intensive processes around a point of focus.

Then, at 208, the meeting experience customization program 150 adjusts stream characteristics for one or more video streams according to user preferences. Adjusting may include, for example, changing colors, text sizes, spacing, window positions, window sizes, items in focus, or visual scale. The meeting experience customization program 150 may, for example, provide one stream to each user or for each set of user preferences. Adjusting may occur on a presenter device, on a participant's device, or on a server computer supporting the video call.

In at least one embodiment, adjusting visual scale may include “zooming in” to a particular part of the screen being shared, such as an area with fonts that are too small, or a point of focus identified at 206. For example, if a presentation is identified as a point of focus, the meeting experience customization program 150 may increase the visual scale of the presentation area so that all text in the presentation is legible according to user preferences set at 204. Adjusting visual scale may include adjusting a size of a window as a relative portion of the screen being shared, or increasing the scale of the whole screen being shared. When increasing the scale of the whole screen being shared, the meeting experience customization program 150 may re-center the shared screen area on a point of focus.

In another embodiment, adjusting text size or text spacing may include resizing text dynamically, such as in a manner that might re-wrap text. Adjusting text spacing may include adjusting leading, kerning, line spacing, or paragraph spacing. For example, adjusting text may identify text in a word processing application, and use an API for the word processing application to create a visual representation of the same text adjusted to a different font size and different leading.

In an alternate embodiment, adjusting text size may be performed by adjusting visual scale of text elements. Other text adjustments may include rotating, repositioning, stretching, or shrinking text. For example, if live video includes text on a park bench that is off on an angle and out of perspective, adjusting may change the perspective and angle of text so that it is visible straight-on.

In yet another embodiment, adjusting may clarify text in images. For example, the meeting experience customization program 150 may identify text on a rusty plaque next to a statue and fill in parts of letters that have been rendered illegible by rust, or convert such letters or all of the text into a legible font. In yet another embodiment, adjusting may include adjusting spacing between items. For example, adjusting may adjust window sizes to minimize space between windows.

In a further embodiment, adjusting may include adjusting color or brightness. For example, if a user prefers high contrast black text on a white background, and the screen being shared includes green text on a dark gray background, adjusting color may include converting the text and background colors for the adjusted output stream for that user to black and white, respectively. Alternatively, the meeting experience customization program 150 may gradually increase contrast and brightness for items near a point of focus and gradually decrease contrast or brightness for items far from a point of focus.

In another embodiment, adjusting may include adjusting colors according to a colorblindness adjustment mode. Colorblindness adjustment modes may adjust colors; brightness levels of the screen, items on the screen, particular colors, or regions; and other characteristics so that users with a particular form of colorblindness can see the adjusted stream clearly, parse adjacent elements easily, and understand the maximum amount of semantic content from the original colors.

In at least one embodiment, adjusting may include adjusting custom output streams for one or more custom recordings. For example, if a user is invited to a meeting, but cannot attend, a recording may be adjusted for, customized for, and sent to the user according to the user's preferences.

In another embodiment, the meeting experience customization program 150 may re-adjust characteristics that have already been adjusted. Adjustment may occur regularly, periodically, continuously, or in response to a change in characteristics identified at 206.

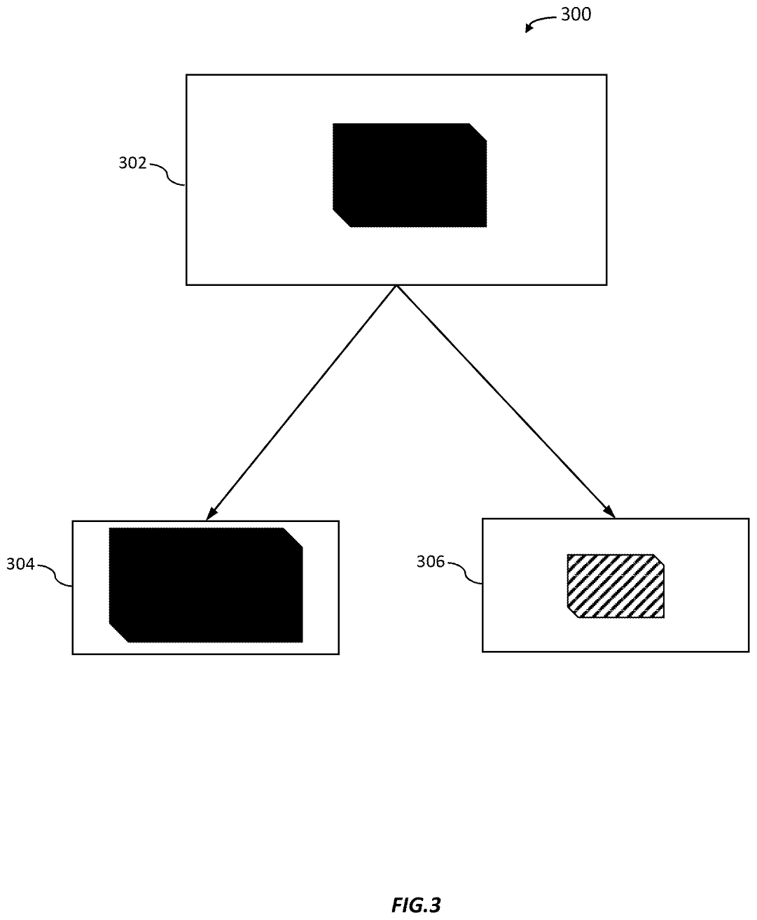

Referring now to FIG. 3, the meeting experience customization program 150 is sharing one screen to two other screens through a process of screen sharing 300 according to at least one embodiment. A presenter's screen 302 displays one or more objects. Objects may include windows, images, text, videos, icons, or any other element of a computer's user interface.

In at least one embodiment, the presenter's screen 302 may be shared to one or more other participants, including participant A's screen 304 and participant B's screen 306. The presenter's screen may display one or more items, windows, or objects, such as a browser window, presentation window, or image. Participant A's screen 304 may include a resized version of an object displayed on the presenter's screen 302. For example, if an image is identified as reflecting insufficient detail on participant A's screen 304 for participant A's preferences, the image may appear on participant A's screen 304 at a larger scale. Furthermore, participant B's screen 306 may include a recolored version of an object on the presenter's screen 302. For example, if participant B is red-green colorblind, color output to participant B's screen 306 may be adjusted according to a red-green colorblind visibility mode. Recoloring may also include changing brightness, transparency, or other color-related features.

It may be appreciated that FIGS. 2 and 3 each provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
initiating a video call;
determining one or more sets of user preferences for each of one or more users;
identifying visual characteristics of a main video stream on the video call; and
adjusting one or more visual characteristics of the main video stream according to the one or more sets of user preferences corresponding to each user to create a custom video stream for each user.

2. The method of claim 1, wherein the one or more sets of user preferences include preferences regarding a text size.

3. The method of claim 1, wherein the identifying is performed by a process of image recognition including text recognition.

4. The method of claim 1, wherein the determining is performed by a process of machine learning.

5. The method of claim 1, further comprising:
selecting one or more points of focus in the main video stream; and
adjusting the relative size of the point of focus.

6. The method of claim 1, wherein the main video stream is video of a presenter's screen.

7. The method of claim 1, wherein the one or more sets of user preferences include preferences regarding text colors.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
initiating a video call;
determining one or more sets of user preferences for each of one or more users;
identifying visual characteristics of a main video stream on the video call; and
adjusting one or more visual characteristics of the main video stream according to the one or more sets of user preferences corresponding to each user to create a custom video stream for each user.

9. The computer system of claim 8, wherein the one or more sets of user preferences include preferences regarding a text size.

10. The computer system of claim 8, wherein the identifying is performed by a process of image recognition including text recognition.

11. The computer system of claim 8, wherein the determining is performed by a process of machine learning.

12. The computer system of claim 8, further comprising:
selecting one or more points of focus in the main video stream; and
adjusting the relative size of the point of focus.

13. The computer system of claim 8, wherein the main video stream is video of a presenter's screen.

14. The computer system of claim 8, wherein the one or more sets of user preferences include preferences regarding text colors.

15. A computer program product, the computer program product comprising:
one or more computer-readable tangible storage medium and program instructions stored on at least one of the one or more tangible storage medium, the program instructions executable by a processor capable of performing a method, the method comprising:
initiating a video call;
determining one or more sets of user preferences for each of one or more users;
identifying visual characteristics of a main video stream on the video call; and
adjusting one or more visual characteristics of the main video stream according to the one or more sets of user preferences corresponding to each user to create a custom video stream for each user.

16. The computer program product of claim 15, wherein the one or more sets of user preferences include preferences regarding a text size.

17. The computer program product of claim 15, wherein the identifying is performed by a process of image recognition including text recognition.

18. The computer program product of claim 15, wherein the determining is performed by a process of machine learning.

19. The computer program product of claim 15, further comprising:
selecting one or more points of focus in the main video stream; and
adjusting the relative size of the point of focus.

20. The computer program product of claim 15, wherein the main video stream is video of a presenter's screen.
